(19) United States
(12) Patent Application Publication
(10) Pub. No.: US 2019/0199458 A1
(43) Pub. Date: Jun. 27, 2019

(54) THRESHOLD DETERMINATION DEVICE AND THRESHOLD DETERMINATION METHOD IN WIRELESS COMMUNICATION SYSTEM

(71) Applicant: KDDI CORPORATION, Tokyo (JP)

(72) Inventors: Tadayuki FUKUHARA, Tokyo (JP); Hiroyuki SHINBO, Tokyo (JP)

(73) Assignee: KDDI CORPORATION, Tokyo (JP)

(21) Appl. No.: 16/222,303

(22) Filed: Dec. 17, 2018

(30) Foreign Application Priority Data
Dec. 26, 2017 (JP) 2017-250094

(51) Int. Cl. H04B 17/318; H04W 76/10

(52) U.S. Cl. CPC H04B 17/318; H04W 92/10; H04W 76/10

(57) ABSTRACT

A threshold determination device aims to automatically determine and change a threshold regarding whether to permit a wireless connection between a base station device and a terminal device depending on wireless communication environments. The threshold determination device is adapted to the base station device configured to measure the received power of a connection request signal from the terminal device and is configured to determine a threshold regarding whether to permit the terminal device to be connected to the base station device in connection with a communication quality indicator (e.g. a user throughput or a terminal connection count). The base station device does not permit a wireless connection with the terminal device when the received power is lower than the threshold. The threshold determination device changes the threshold depending on a target value and a measured value of the communication quality indicator.

### CROSS-REFERENCE TO RELATED APPLICATION

The present application claims the priority benefit of Japanese Patent Application No. 2017-250094 filed on Dec. 26, 2017, the subject matter of which is hereby incorporated herein by reference.

### BACKGROUND OF THE INVENTION

### 1. Field of the Invention

The present invention relates to a wireless communication system, and in particular to a threshold determination device and a threshold determination method for determining thresholds regarding a decision as to whether or not to permit a terminal device to be connected to a base station device.

### 2. Description of Related Art

Technologies for improving quality of communication between base station devices and terminal devices in wireless communication systems have been developed and disclosed in various documents such as Patent Document 1 and Non-Patent Documents 1, 2. Those technologies provide thresholds for guaranteeing good quality communication between base station devices and terminal devices and thereby permit terminal devices satisfying thresholds to be connected to base station devices.

Specifically, Patent Document 1 discloses a base station device for improving connectivity with each terminal device using a first threshold for guaranteeing good quality communication and a second threshold for determining whether to locate each terminal device in a predetermined area. Non-Patent Document 1 discloses a wireless LAN using CSMA/CA (Carrier Sense Multiple Access with Collision Avoidance) to improve spatial frequency utilization efficiency by controlling carrier sense thresholds and transmitting power according to spatial spectrum usage using RSSI (Received Signal Strength Indicator). Non-Patent Document 2 discloses RX-SOP (Receiver Start of Packet Detection Threshold) values used to determine Wi-Fi signal levels in dBm for access points having transceivers to demodulate and decode packets.
Patent Document 1: Japanese Patent Application Publication No. 2008-072669
Non-Patent Document 1: Aya SASAKI, Masahiro UMEHIRA, “A RSSI Based Carrier Sense Threshold Control Scheme for Densely Deployed Wireless LAN”, the Institute of Electronics, Information and Communication Engineer, Shingaku-Giho, RCS2012-235, December 2012, pp. 309-314
Non-Patent Document 2: Cisco Systems LLC, “High-Density Experience (HDX) Deployment Guide, Release 8.0, Chapter 2: High-Density Experience Function Added by Release 8.0. RX-SOP (Receiver Start of Packet Detection Threshold)”, Aug. 12, 2014, the Internet <URL: https://www.cisco.com/c/ja_jp/td/docs/wl/accesspoint/aironet3700/techref/001/b_hdx_dg_final/pdf>

The quality of communication between base station devices and terminal devices (e.g. throughputs of terminal devices) may fluctuate due to wireless environments represented by the number of terminal devices located in communication areas of base station devices and time zones used for communications. For example, terminal devices may be reduced in terms of their throughput of communication depending on wireless environments significantly interfering communication with other devices or in wireless environments causing congestion of communication due to a relatively large number of terminal devices located in communication areas and a time zone undergoing a high communication rate with each terminal device. In contrast, terminal devices may be improved in terms of their communication throughput depending on wireless environments causing a low degree of communication due to a relatively small number of terminal devices located in communication areas and a time zone undergoing a low communication rate with terminal devices.

However, the foregoing technologies are designed without considering how to change thresholds used to select terminal devices which are permitted to be connected to base station devices depending on wireless environments due to the number of terminal devices located in communication areas of base station devices and time zones for carrying out communications.

The present invention is made in consideration of the aforementioned circumstances, and therefore, the present invention aims to automatically change thresholds used to select terminal devices which are permitted to be connected to base station devices depending on wireless environments in communication areas of base station devices.

### SUMMARY OF THE INVENTION

A first aspect of the invention relates to a base station device wirelessly connectible to a terminal device. The base station device includes a received power determination part configured to determine the received power of a connection request signal from a terminal device, and a threshold determination part configured to determine a threshold regarding whether to permit a wireless connection with the terminal device in connection with a communication quality indicator. A wireless connection is permitted to the terminal device when the received power is higher than the threshold. The threshold determination part changes the threshold depending on a target value and a measured value of the communication quality indicator.

A second aspect of the invention relates to a threshold determination device adapted to a base station device configured to measure the received power of a connection request signal from a terminal device. The threshold determination part includes a threshold determination part configured to determine a threshold regarding whether to permit the terminal device to be connected to the base station device in connection with a communication quality indicator. The base station device does not permit the terminal device to be connected thereto when the received power is lower than the threshold. The threshold determination part changes the threshold depending on a target value and a measured value of the communication quality indicator.

A third aspect of the invention relates to a threshold determination method adapted to a base station device configured to measure the received power of a connection request signal from a terminal device. The threshold determination method includes steps of: determining a threshold regarding whether to permit the terminal device to be connected to the base station device with respect to a communication quality indicator; and changing the threshold depending on a target value and a measured value of the communication quality indicator. The base station device does not permit the terminal device to be connected thereto when the received power is lower than the threshold.

According to the present invention, it is possible to obtain an effect of automatically changing a threshold regarding whether to permit a wireless connection between a terminal device and a base station device depending on wireless communication environments in the communication area of the base station device.

### BRIEF DESCRIPTION OF THE DRAWINGS

FIG. 1 is a block diagram showing a configuration example of a wireless communication system according to the first embodiment of the present invention.

FIG. 2 is a flowchart showing a method of determining a connection permission with a terminal device by a base station device.

FIG. 3 is a flowchart showing a threshold determination method of determining a threshold used for a connection permission with a terminal device by a base station device.

FIG. 4 is a graph for explaining a threshold determination method according to Example 1.

FIG. 5 is a graph for explaining a threshold determination method according to Example 2.

FIG. 6 is a block diagram showing a configuration example of a wireless communication system according to the second embodiment of the present invention.

### DETAILED DESCRIPTION OF THE EMBODIMENTS

The present invention will be described in detail by way of embodiments with reference to the drawings. The present embodiments refer to a wireless LAN (Local Area Network) as an example of wireless communication systems.

### 1. First Embodiment

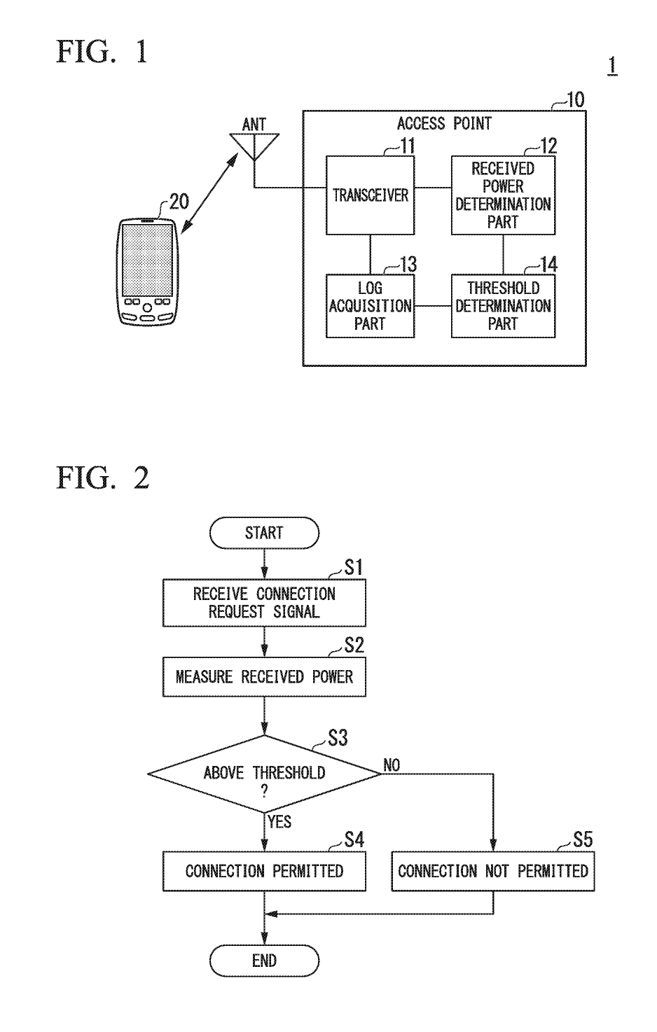

FIG. 1 is a block diagram showing a configuration example of a wireless communication system according to the first embodiment of the present invention. FIG. 1 shows a wireless communication system 1 including a wireless LAN access point (AP) 10 (e.g. a base station device) and a terminal device 20. The access point 10 further includes an antenna ANT, a transceiver 11, a received power determination part 12, a log acquisition part 13, and a threshold determination part 14.

The transceiver 11 receives or transmits radio signals with the terminal device 20 via the antenna ANT. The transceiver 11 has a function to measure communication quality indicators. As communication quality indicators, for example, it is possible to mention received signal strength indicators (RSSI), user throughputs, numbers of terminals connected to each base station device (hereinafter, referred to as terminal connection counts), packet retransmission rates, and modulation rates.

The transceiver 11 receives a connection request signal from the terminal device 20 and thereby measures its RSSI, thus sending a measured RSSI value regarding the terminal device 20 to the received power determination part 12. The received power determination part 12 receives the measured RSSI value regarding the terminal device 12 from the transceiver 11. The received power determination part 12 compares the measured RSSI value regarding the terminal device 20 with an RSSI threshold. The RSSI threshold is determined by the threshold determination part 14 and then set to the received power determination part 12.

The received power determination part 12 determines to permit the terminal device 20 to be connected to the access point 10 when the measured RSSI value regarding the terminal device 20 is equal to or higher than the RSSI threshold. In contrast, the received power determination part 12 determines not to permit the terminal device 20 to be connected to the access point 10 when the measured RSSI value regarding the terminal device 20 is lower than the RSSI threshold. The received power determination part 12 sends connect-permit determination information, representing permission or non-permission whether or not to permit the terminal device 20 to be connected to the access point 10, to the transceiver 11. The transceiver 11 receives the connect-permit determination information regarding the terminal device 20 from the received power determination part 12.

When the connect-permit determination information indicates permission of connection for permitting the terminal device 20 to be connected to the access point 10, the transceiver 11 sends back a connect-permit signal representing permission of connection to the terminal device 20. When the connect-permit determination information indicates non-permission of connection for not permitting the terminal device 20 to be connected to the access point 10, the transceiver 11 does not send back a connect-permit signal to the terminal device 20, or the transceiver 11 sends back a non-connect-permit signal representing non-permission of connection to the terminal device 20. Accordingly, the access point 10 permit the terminal device 20 to be connected thereto when the connection request signal received from the terminal device 20 indicates the received power equal to or higher than the threshold, while the access point 10 does not permit the terminal device 20 to be connected thereto when the received power is lower than the threshold. The present embodiment uses an RSSI as the information representing the received power; however, it is possible to use other information representing the received power.

The transceiver 11 measures communication quality indicators and thereby sends measures values of communication quality indicators to the log acquisition part 13. The log acquisition part 13 receives measured values of communication quality indicators from the transceiver 11. The log acquisition part 13 stores measured values of communication quality indicators in connection with measurement environment information such as times and positions of measuring communication quality indicators.

The threshold determination part 14 determines RSSI thresholds to be set to the received power determination part 12. The threshold changes RSSI thresholds depending on measured values of communication quality indicators stored on the log acquisition part 13 and target values of communication quality indicators regarding the access point 10. The threshold determination part 14 sets RSSI thresholds to the received power determination part 12.

The constituent elements of the access point 10 shown in FIG. 1 may be embodied using specialized hardware. Alternatively, the constituent elements of the access point 10 may be embodied using a CPU (Central Processing Unit) and a memory device, wherein the CPU may execute computer programs to achieve the functions of the constituent elements of the access point 10.

Next, a connect-permit determination process executed by the access point 10 of the present embodiment will be described with reference to FIG. 2. FIG. 2 is a flowchart showing the connect-permit determination process according to the present embodiment.

### (Step S1)

The access point 10 receives a connection request signal from the terminal device 20.

### (Step S2)

The transceiver 11 receives the connection request signal from the terminal device 20 and thereby measures its RSSI. The transceiver 11 sends a measured RSSI value regarding the terminal device 20 to the received power determination part 12.

### (Step S3)

The received power determination part 12 compares the measured RSSI value of the terminal device 20 with the RSSI threshold. According to the result of comparison, the processing proceeds to step S4 when the measured RSSI value is equal to or higher than the RSSI threshold. On the other hand, the processing proceeds to step S5 when the measured RSSI value of the terminal device 20 is lower than the RSSI threshold.

### (Step S4)

The received power determination part 12 determines to permit the terminal device 20 to be connected to the access point 10 when the measured RSSI value of the terminal device 20 is equal to or higher than the RSSI threshold. That is, the received power determination part 12 sends connect-permit determination information representing permission of connection with the terminal device 20, to the transceiver 11. The transceiver 11 sends back a connect-permit signal, representing permission of connection, to the terminal device 20 because the connect-permit determination information represents permission of connection with the terminal device 20. After execution of step S4, the access point 10 exits the processing shown in FIG. 2.

### (Step S5)

The received power determination part 12 determines not to permit the terminal device 20 to be connected to the access point 10 when the measured RSSI value of the terminal device 20 is lower than the RSSI threshold. The received power determination part 12 sends connect-permit determination information, representing non-permission of connection with the terminal device 20, to the transceiver 11. The transceiver 11 does not send back a connect-permit signal to the terminal device 20 because the connect-permit determination information represents non-permission of connection with the terminal device 20. Alternatively, the transceiver 11 may send back a non-connection-permit signal, representing non-permission of connection, to the terminal device 20 when the connect-permit determination information represents non-permission of connection with the terminal device 20. After execution of step S5, the access point 10 exits the processing of FIG. 2.

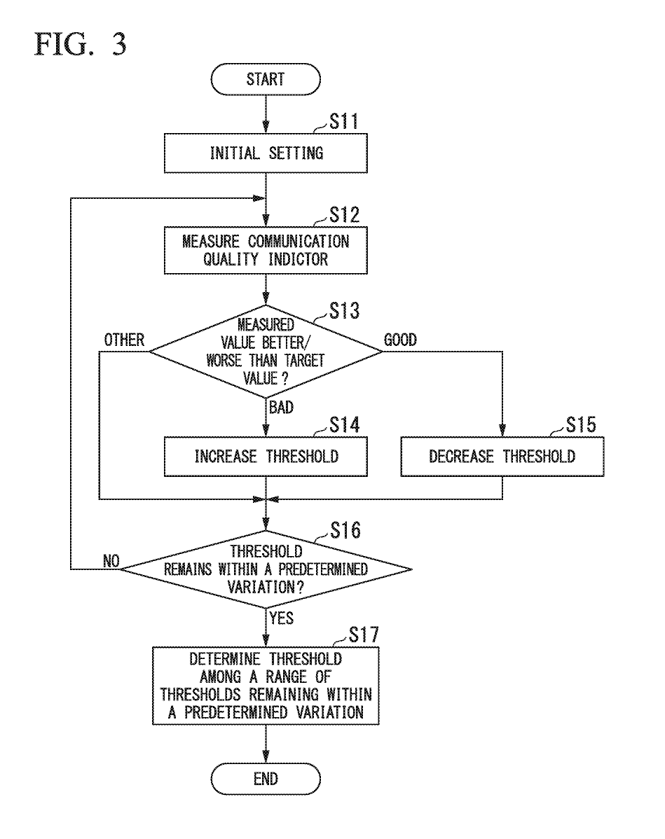

Next, a threshold determination process executed by the access point 10 according to the present embodiment will be described with reference to FIG. 3. FIG. 3 is a flowchart showing the threshold determination process according to the present embodiment.

### (Step S11)

The threshold determination part 14 carries out initial settings. In initial settings, the threshold determination part 14 sets an initial value as an RSSI threshold while setting a target value of a communication quality indicator. Using the initial value of an RSSI threshold, the received power determination part 12 starts to carry out the connect-permit determination process shown in FIG. 2.

### (Step S12)

The transceiver 11 measures communication quality indicators. The threshold determination part 14 acquires measured values of communication quality indicators via the log acquisition part 13.

### (Step S13)

The threshold determination part 14 compares the measured value of a communication quality indicator with the target value of a communication quality indicator. According to the results of comparison, the processing proceeds to step S14 when the measured value of a communication quality indicator represents a lower communication quality than the target value of a communication quality indicator. On the other hand, the processing proceeds to step S15 when the measured value of a communication quality indicator represents a higher communication quality than the target value of a communication quality indicator. In other cases, the processing proceeds directly to step S16 without changing the RSSI threshold.

### (Step S14)

The threshold determination part 14 increases the RSSI threshold by a predetermined increment u when the measured value of a communication quality indicator represents a lower communication quality than the target value of a communication quality indicator. The threshold determination part 14 produces a new RSSI threshold by increasing the RSSI threshold by the predetermined increment u and thereby sets the new RSSI threshold to the received power determination part 12. Using the newly set RSSI threshold, the received power determination part 12 carries out the connect-permit determination process of FIG. 2.

An advantageous effect of increasing the RSSI threshold in step S14 will be described below. By increasing the RSSI threshold, it is possible to increase the lower-limit value of received power in the access point 10 when permitting the terminal device 20 to be connected to the access point 10. Among the terminal devices 20 connectible to the access point 10 before changing (or increasing) the RSSI threshold, some of the terminal devices 20 causing the received power of the access point 10 below the changed (or increased) RSSI threshold may not be connected to the access point 10. After changing the RSSI threshold, it is possible to increase the received power of the access point 10 connectible to the terminal device 20 to be higher than previous received power applied to the previous time before changing the RSSI threshold. This operation may produce an effect of improving the throughput of the terminal device 20 connected to the access point 10.

Since the terminal device 20, which was previously connected to the access point 10 before changing (or increasing) the RSSI threshold, is no longer connectible to the access point 10 due to an increase of the RSSI threshold, it is possible to release wireless resources which were used by the “currently disconnected” terminal device 20 in the previous time before changing (or increasing) the RSSI threshold, and therefore, it is possible to use the released wireless resources with respect to another terminal device 20 which can be connected to the access point 10 after changing (or increasing) the RSSI threshold. Accordingly, it is possible to produce an effect of further improving the throughput of the terminal device 20 connected to the access point 10.

### (Step S15)

The threshold determination part 14 decreases the RSSI threshold by a predetermined decrement d when the measured value of a communication quality indicator represents a higher communication quality than the target value of a communication quality indicator. The threshold determination part 14 produces a new RSSI threshold by decreasing the RSSI threshold and thereby sets the new RSSI threshold to the received power determination part 12. Using the newly set RSSI threshold, the received power determination part 12 carries out the connect-permit determination process of FIG. 2.

An advantageous effect of decreasing the RSSI threshold in step S15 will be described below. By decreasing the RSSI threshold, it is possible to reduce the lower-limit value of the received power of the access point 10 for permitting the terminal device 20 to be connected to the access point 10. Among the terminal devices 20 not connectible to the access point 10 before changing (or decreasing) the RSSI threshold, some of the terminal devices 20 causing the received power of the access point 10 above the changed (or decreased) RSSI threshold may be connected to the access point 10. Accordingly, after changing the RSSI threshold, it is possible to produce an effect of increasing the number of terminal devices 20 connectible to the access point 10 to be larger than the previous number of terminal devices 20 connectible to the access point 10 before changing the RSSI threshold.

### (Step S16)

The threshold determination part 14 determines whether or not the RSSI threshold remains within a predetermined variation w. According to the results of determination, the processing proceeds to step S17 when the RSSI threshold remains in the predetermined variation w, otherwise, the processing returns to step S12.

By setting the predetermined variation w to “w=0”, it is possible to normally set the determination result of step S16 to “NO”, and therefore, the access point 10 will repeat a series of steps from S12 to S16; hence, it is possible to continuously change the RSSI threshold.

### (Step S17)

The threshold determination part 14 determines the RSSI threshold, which is set to the received power determination part 12, within the predetermined variation w. The threshold determination part 14 determines and sets the RSSI threshold to the received power determination part 12. Using the newly set RSSI threshold, the received power determination part 12 carries out the connect-permit determination process of FIG. 2. After executing step S17, the access point 10 exits the processing of FIG. 3.

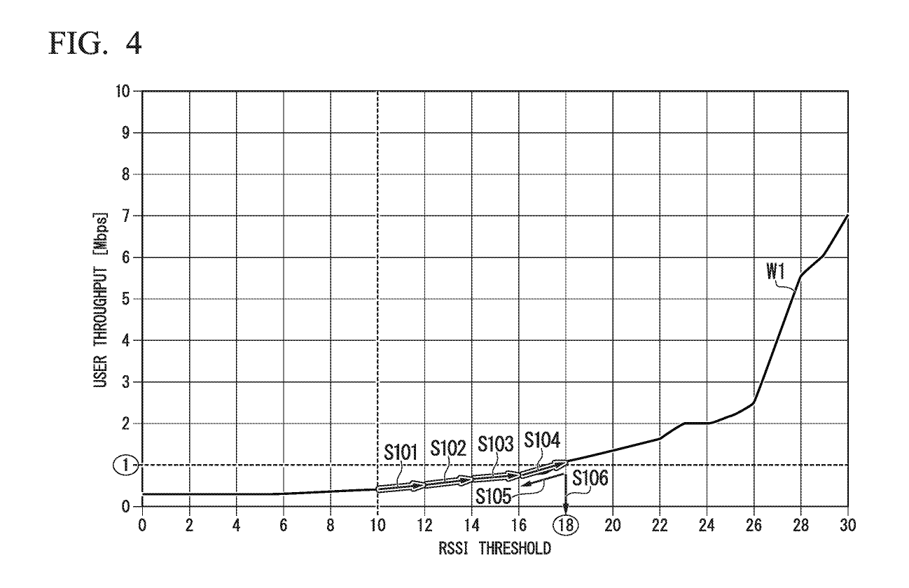

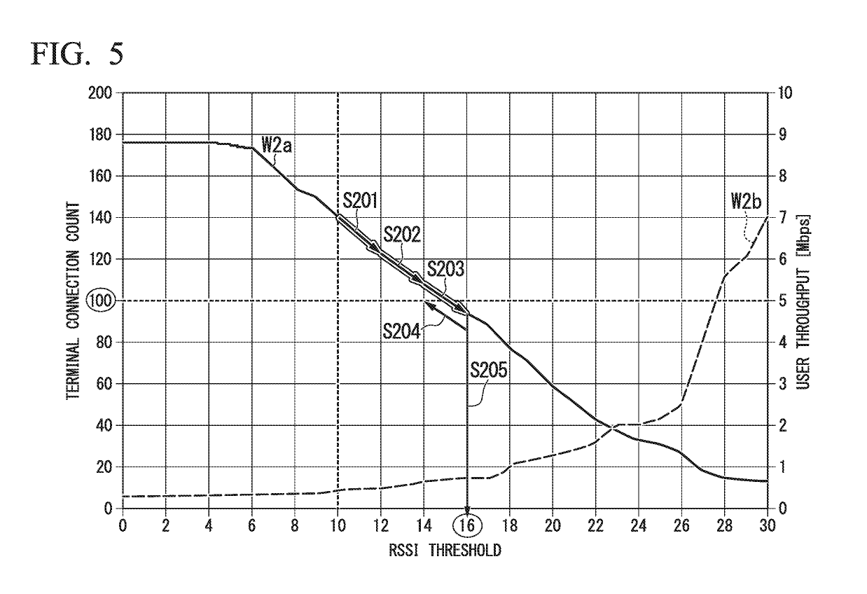

Next, examples of threshold determination processes according to the present embodiment will be described with reference to FIGS. 4 and 5.

### Example 11

The threshold determination method according to Example 1 of the present embodiment will be described with reference to FIG. 4. FIG. 4 is a graph used for explaining the threshold determination method according to Example 1 of the present embodiment. Herein, Example 1 refers to a user throughput as a communication quality indicator. The user throughput is an average value of throughputs achieved by all the terminal devices 20 connected to the access point 10. In FIG. 4, the vertical axis represents user throughput in units of megabits per second (Mbps) while the horizontal axis represents RSSI threshold. A solid curve WI shows an example of the relationship between the user throughput and the RSSI threshold. The solid curve W1 is used for the purpose of explaining the threshold determination method of Example 1. In FIG. 4, an initial value of the RSSI threshold is set to “10” while a target value of the user throughput is set to 1 Mbps.

In the initial setting in step S11 of FIG. 3, the threshold determination part 14 sets an initial value “10” to the RSSI threshold while setting a target value “1 Mbps” to the user throughput. FIG. 4 shows a measured value of the user throughput (hereinafter, simply referred to as a measured user throughput) on the solid curve W1 at the RSSI threshold “10”, which is lower than the target value “1 Mbps” of the user throughput (hereinafter, a target value of the user throughput will be referred to as a target user throughput), in other words, the measured user throughput indicates a lower communication quality than the target user throughput. Accordingly, the threshold determination part 14 increases the RSSI threshold by a predetermined increment u (e.g. u=2 in FIG. 4) and thereby sets the increased RSSI threshold “12” to the received power determination part 12 in step S101.

Subsequently, it is determined that the measured user throughput on the solid curve W1 at the RSSI threshold “12” is lower than the target user throughput of 1 Mbps, and therefore, the threshold determination part 14 further increases the RSSI threshold by the predetermined increment “2” and thereby sets the increased RSSI threshold “14” to the received power determination part 12 in step S102. Additionally, it is determined that the measured user threshold on the solid curve W1 at the RSSI threshold “14” is lower than the target user throughput of 1 Mbps, and therefore, the threshold determination part 14 further increases the RSSI threshold by the predetermined increment “2” and thereby sets the increased RSSI threshold “16” to the received power determination part 12 in step S103. Moreover, it is determined that the measured user threshold on the solid curve W1 at the RSSI threshold “16” is lower than the target user throughput of 1 Mbps. and therefore, the threshold determination part 14 further increases the RSSI threshold by the predetermined increment “2” and thereby sets the increased RSSI threshold “18” to the received power determination part 12 in step S104.

Subsequently, it is determined that the measured user throughput on the solid curve W1 at the RSSI threshold “18” exceeds the target user throughput of 1 Mbps, in other words, the measured user throughput indicates a higher communication quality than the target user throughput. Thus, the threshold determination part 14 decreases the RSSI threshold by a predetermined decrement d (e.g. d=2 in FIG. 4) and thereby sets the decreased RSSI threshold “16” to the received power determination part 12 in step S105. Thereafter, the RSSI threshold remains within a predetermined variation w (e.g. w=2 in FIG. 4), and therefore, the threshold determination part 14 determines an RSSI threshold to be set to the received power determination part 12 within a range of RSSI thresholds, e.g. a range between “16” and “18”, each of which remains within a predetermined variation “2”. In the case of FIG. 4, the threshold determination part 14 selects the maximum RSSI threshold “18” among a range of RSSI thresholds, i.e. a range between “16” and “18”, each of which remains in the predetermined variation “2”, as the RSSI threshold to be set to the received power determination part 12. That is, the threshold determination part 14 sets the selected RSSI threshold “18” to the received power determination part 12 in step S106.

According to Example 1, the access point 10 changes the RSSI threshold according to the relationship between the target user throughput and the measured user throughput. That is, the access point 10 increases the RSSI threshold by the predetermined increment when the measured user throughput is lower than the target user throughput, in other words, when the measured user throughput indicates a lower communication quality than the target user throughput. Accordingly, it is possible to increase the received power of the terminal device 20 connected to the access point 10 after changing the RSSI threshold rather than before changing the RSSI threshold, and therefore, it is possible to obtain an effect of improving the throughput of the terminal device 20 connected to the access point 10. In addition, it is possible to release wireless resources used for one terminal device 20 which is no longer connectible to the access point 10 after changing the RSSI threshold, thus reusing the released wireless resources for another terminal device 20 connected to the access point 10. Accordingly, it is possible to obtain an effect of further improving the throughput of the terminal device 20 connected to the access point 10.

In contrast, the access point 10 decreases the RSSI threshold by the predetermined decrement when the measured user throughput exceeds the target user throughput, in other words, when the measured user throughput indicates a higher communication quality than the target user throughput. Accordingly, it is possible to reduce the lower-limit value of the received power of the access point 10 with respect to the terminal device 20 which is permitted to be connected to the access point 10. Therefore, it is possible to obtain an effect of increasing the number of terminal devices 20 connectible to the access point 10 after changing the RSSI threshold rather than before changing the RSSI threshold.

For example, each terminal device 20 would be reduced in terms of its throughput in congested wireless communication environments due to a large number of terminal devices 20 located in the communication area of the access point 10 or due to time zones undergoing a large amount of communication with each terminal device 20. According to Example 1, however, it is possible to reduce the number of terminal devices 20 limited to terminal devices 20 demonstrating high communication quality by increasing the RSSI threshold, and therefore, it is possible to maintain high communication quality with the reduced number of terminal devices 20 connectible to the access point 10. On the other hand, each terminal device 20 would be improved in terms of its throughput in free (non-congested) wireless communication environments due to a small number of terminal devices 20 located in the communication area of the access point 10 or due to time zones undergoing a small amount of communication with each terminal device 20. According to Example 1, however, it is possible to secure an adequate number of terminal devices 20 connectible to the access point 10 using the terminal device(s) 20 demonstrating low communication quality by decreasing the RSSI threshold. In addition, the threshold determination method according to Example 1 is able to change the RSSI threshold based on measurement results of user throughputs, hence, it is possible to change the RSSI threshold in consideration of a negative influence due to degradation of communication quality in places undergoing high radio interference.

According to Example 1 as described above, it is possible to obtain an effect of automatically changing the RSSI threshold depending on wireless environments in the communication area of the access point 10.

### Example 2

A threshold determination method according to Example 2 of the present embodiment will be described with reference to FIG. 5. FIG. 5 is a graph used for explaining the threshold determination method according to Example 1 of the present embodiment. Herein, Example 2 refers to a terminal connection count as a communication quality indicator. The terminal connection count represents the total number of terminal devices 20 connected to the access point 10. In FIG. 4, the left vertical axis represents terminal connection count; the right vertical axis represents user throughput in units of Mbps; and the horizontal axis represents RSSI threshold. In FIG. 5, a solid curve W2a shows an example of the relationship between the terminal connection count and the RSSI threshold, which is used for the purpose of explaining Example 2. A solid curve W2b shows an example of the relationship between the user throughput and the RSSI threshold, which is used for the purpose of explaining Example 2. In FIG. 5, an initial value of the RSSI threshold is set to “10” while a target value of the terminal connection count (hereinafter, simply referred to as a target terminal connection count) is set to “100”.

In the initial setting in step S11 of FIG. 3, the threshold determination part 14 sets the initial value “10” to the RSSI threshold while setting the target value “100” to the terminal connection count. FIG. 5 shows that a measured value of the terminal connection count (hereinafter, simply referred to as a measured terminal connection count) on the solid curve W2a at the RSSI threshold “10” exceeds the target terminal connection count “100”, in other words, the measured terminal connection count is higher than the target terminal connection count. Accordingly, the threshold determination part 14 increases the RSSI threshold by a predetermined increment u (e.g. u=2 in FIG. 5) and thereby the increased RSSI threshold “12” to the received power determination part 12 in step S201.

Subsequently, it is determined that the measured terminal connection count on the solid curve W2a at the RSSI threshold “12” still exceeds the target terminal connection count “100”, and therefore, the threshold determination part 14 further increases the RSSI threshold by the predetermined increment “2” and thereby sets the increased RSSI threshold “14” to the received power determination part 12 in step S202. In addition, it is determined that the measured terminal connection count on the solid curve W2a at the RSSI threshold “14” still exceeds the target terminal connection count “100”, and therefore, the threshold determination part 14 further increases the RSSI threshold by the predetermined increment “2” and thereby sets the increased RSSI threshold “16” to the received power determination part 12 in step S203.

Subsequently, it is determined that the measured terminal connection count on the solid curve W2a at the RSSI threshold “16” is lower than the target terminal connection count “100”, in other words, the measured terminal connection count is higher than the target terminal connection count. Accordingly, the threshold determination part 14 decreases the RSSI threshold by a predetermined decrement d (e.g. d=2 in FIG. 5) and thereby sets the decreased RSSI threshold “14” to the received power determination part 12 in step S204. Thereafter, the RSSI threshold remains in a predetermined variation w (e.g. w=2 in FIG. 5), and therefore, the threshold determination part 14 select the RSSI threshold among a range of RSSI thresholds, i.e. a range between “14” and “16”, each of which remains in the predetermined variation “2”, thus setting the selected RSSI threshold to the received power determination part 12. In FIG. 5, the threshold determination part 14 selects the RSSI threshold “16” among a range of RSSI thresholds, i.e. a range between “14” and “16”, each of which remains in the predetermined variation “2”, thus setting the RSSI threshold to the received power determination part 12. That is, the threshold determination part 14 sets the selected RSSI threshold “16” to the received power determination part 12 in step S205.

According to Example 2 described above, the access point 10 changes the RSSI threshold depending on the measured terminal connection count and the target terminal connection count. The access point 10 increases the RSSI threshold by the predetermined increment when the measured terminal connection count exceeds the target terminal connection count, in other words, when the measured terminal connection count is higher than the target terminal connection count. Accordingly, it is possible to prevent the terminal device(s) 20 indicating measured RSSI thresholds lower than the changed RSSI threshold among the terminal devices 20 previously connectible to the access point 10 before changing the RSSI threshold from being connected to the access point 10; hence, it is possible to reduce the number of terminal devices 20 corresponding to an excess count above the target terminal connection count of the access point 10. Therefore, it is possible to release wireless resources previously used for the terminal device(s) 20 which are no longer connectible to the access point 10 after changing the RSSI threshold, thus reusing the released wireless resources for other terminal device(s) 20. Accordingly, it is possible to obtain an effect of improving the throughput of the terminal device 20 connected to the access point 10. In addition, the received power of the terminal device 20 connected to the access point 10 would be increased after changing the RSSI threshold rather than before changing the RSSI threshold, and therefore, it is possible to obtain an effect of further improving the throughput of the terminal device 20 connected to the access point 10.

On the other hand, the access point 10 decreases the RSSI threshold by the predetermined decrement when the measured terminal connection count is lower than the target terminal connection count, in other words, when the measured terminal connection count is lower than the target terminal connection count. Accordingly, it is possible to connect the terminal device(s) 20, the number of which corresponds to an excess count above the target terminal connection count after changing the RSSI threshold among the terminal device(s) 20 which were not connectible to the access point 10 before changing the RSSI threshold, to the access point 10; hence, it is possible to compensate for a shortage below the target terminal connection count.

According to Example 2, the access point 10 increases the RSSI threshold in wireless communication environments having an excessive terminal connection count of the access point 10 due to a large number of terminal devices 20 located in the communication area of the access point 10. Accordingly, it is possible to reduce the number of terminal devices 20 limited to the terminal devices 20 indicating high communication quality by increasing the RSSI threshold, and therefore, it is possible to secure an adequate number of terminal devices 20 connectible to the access point 10, thus achieving high communication quality with the terminal devices 20. On the other hand, the access point 10 decreases the RSSI threshold in wireless communication environments having a very small terminal connection count due to a small number of terminal devices 20 located in the communication area of the access point 10. Accordingly, it is possible to further connect the terminal device(s) to the access point 10, thus securing an adequate number of terminal devices 20 connectible to the access point 10.

According to Example 2 as described above, it is possible to obtain an effect of automatically changing the RSSI threshold depending on wireless communication environments in the communication area of the access point 10.

### [Variations]

Next, variations will be described below. In Examples 1, 2, both the increment u and the decrement d for increasing and decreasing the RSSI threshold are set to the same value (i.e. u=d=2 in FIGS. 4 and 5); however, the increment u may differ from the decrement d. Alternatively, it is possible to modify Examples 1, 2 such that a variation (i.e. the increment u or the decrement d) of the RSSI threshold will be increased until the measured value of a communication quality indicator reaches the target value of a communication quality indicator at first while the variation of the RSSI threshold will be decreased after the measured value of a communication quality indicator reaches the target value of a communication quality indicator.

It is possible to set the initial value of the RSSI threshold to the access point 10 in advance. Alternatively, the access point 10 may autonomously determine the initial value of the RSSI threshold. For example, it is possible for the access point 10 to determine the initial value of the RSSI threshold by way of (i) accumulating measured values of RSSI thresholds for a predetermined period of time, (ii) determining the minimum value of the RSSI threshold based on the measured values of RSSI thresholds, and (iii) determining the initial value of the RSSI threshold based on the minimum value of the RSSI threshold. That is, it is possible to set the minimum value of the RSSI threshold, which is obtained by measurement and determination results, as the initial value of the RSSI threshold.

Alternatively, it is possible to set the lower-limit value of the RSSI threshold such that the RSSI threshold will be controlled not to become lower than the lower-limit value. In addition, it is possible to change the lower-limit value of the RSSI threshold depending on wireless communication environments in the communication area of the access point 10. For example, it is possible to raise the lower-limit value of the RSSI threshold when a plurality of terminal devices 20 are concentrated in the communication area of the access point 10 at high density, thus preventing the terminal device(s) 20 indicating low communication quality from being connected to the access point 10. On the other hand, it is possible to lower the lower-limit value of the RSSI threshold when a plurality of terminal devices 20 are located in the communication area of the access point 10 at low density, thus securing an adequate terminal connection number.

In addition, it is possible to appropriately change the target value of a communication quality indicator. To emphasize the terminal connection count in wireless communication, for example, it is possible to reduce the target value of a user throughput. Based on calendar information showing weekdays and national holidays, for example, it is possible to change the target value of a communication quality indicator differently with respect to weekdays and nonbusiness days such as Saturdays, Sundays, and national holidays.

The foregoing embodiment is designed to use “RSSI” as the information representing the received power; however, it is possible to use other information other than the received power.

As communication quality indexes, Example 1 uses the user throughput while Example 2 uses the terminal connection count, however, it is possible to use other communication quality indexes. As other communication quality indexes, for example, it is possible to employ packet retransmission rates and modulation rates.

In summary, the threshold determination part 14 automatically increases or decreases the RSSI threshold to reduce a difference between the measured value and the target value of a communication quality indicator (e.g. a user throughput or a terminal connection count). As shown in FIG. 4, in which the RSSI threshold increases in proportion to the user throughput, the threshold determination part 14 automatically increases the RSSI threshold as long as the measured value of the user throughput is lower than the target value of the user throughput. As shown in FIG. 5, in which the RSSI threshold increases inversely proportionally to the terminal connection count, the threshold determination part 14 automatically increases the RSSI threshold as long as the measured value of the terminal connection count is higher than the target value of the terminal connection count.

### 2. Second Embodiment

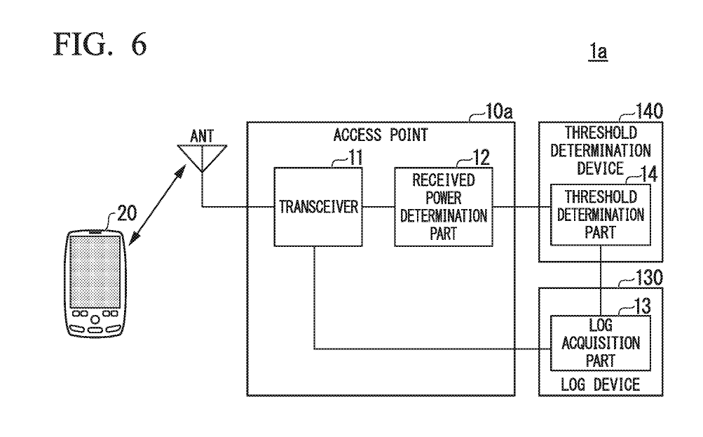

The first embodiment shown in FIG. 1 is designed such that the access point 10 includes the threshold determination part 14; however, it is possible to separate the threshold determination part 14 from the access point 10. FIG. 6 is a block diagram showing the configuration of a wireless communication system 1a according to the second embodiment of the present invention. In FIG. 6, the same parts as the foregoing parts shown in FIG. 1 are designated using the same reference symbols; hence, their descriptions will be omitted here.

In FIG. 6, the wireless communication system 1a includes an access point 10a, a log acquisition device 130, and a threshold determination device 140 in addition to the terminal device 20. Similar to the access point 10, the access point 10a includes the transceiver 11 and the received power determination part 12. The threshold determination device 140 includes the threshold determination part 14 while the log acquisition device 130 includes the log acquisition part 13. That is, the wireless communication system 1a of FIG. 6 differs from the wireless communication system 1 of FIG. 1 in that the threshold determination part 14 and the log acquisition part 13 are incorporated into independent devices 140 and 130 separated from the access point 10a. Similar to the wireless communication system 1 of FIG. 1, the wireless communication system 1a of FIG. 6 is able to carry out the connect-permit determination method of FIG. 2 and the threshold determination method of FIG. 3.

As described in the foregoing embodiments and Examples 1, 2, it is possible to obtain an effect of automatically changing the RSSI threshold depending on wireless communication environments in the communication area of the access point 10. This may preclude a manual operation to set and change the RSSI threshold manually: hence, it is possible for the foregoing embodiments to achieve an operation to automatically set and change the RSSI threshold at high speed and at low cost.

The present invention is described in detail by way of the foregoing embodiments with reference to the accompanying drawings; however, concrete configurations are not necessarily limited to the foregoing embodiments, and therefore, the present invention may embrace any changes of design without departing from the essential matters of the invention.

In this connection, the foregoing embodiments are applied to wireless LAN systems exemplifying wireless communication systems; however, they may be applied to any wireless communication systems other than wireless LAN systems.

In addition, it is possible to store computer programs for achieving the functions of the foregoing devices on computer-readable storage media, whereby computer systems may load computer programs from storage media and thereby execute computer programs. The term “computer-readable storage media” may cover software such as operating systems (OS) and hardware such as peripheral devices. As “computer-readable storage media”, it is possible to mention flexible disks, magneto-optical disks, ROM, rewritable non-volatile memory such as flash memory, potable media such as digital versatile disks (DVD), and storage devices such as hard drives embedded in computer systems.

In addition, it is possible to transmit programs which are read from storage devices of computer systems to other computer systems via transmission media or via radio waves propagating through transmission media. Herein, the term “transmission media” used to transmit programs can be regarded as any media having the function to transmit information, e.g. networks (or communication networks) such as the Internet, and communication lines such as telephone lines.

Moreover, the foregoing programs may achieve some of the foregoing functions. Alternatively, the foregoing programs may be differential files (or differential programs) which can be combined with pre-installed programs which are pre-installed in computer systems to achieve the foregoing functions.

Lastly, the present invention is not necessarily limited to the foregoing embodiments, Examples 1, 2, and variations, which are illustrative and not restrictive. Therefore, the present invention may embrace any changes of design, modifications, and replacements of parts within the scope of the invention as defined in the appended claims.

1. A base station device wirelessly connectible to a terminal device, comprising:
a received power determination part configured to determine received power of a connection request signal from the terminal device; and
a threshold determination part configured to determine a threshold regarding whether to permit a wireless connection with the terminal device in connection with a communication quality indicator,
wherein the wireless connection is not permitted to the terminal device when the received power is lower than the threshold, and
wherein the threshold determination part changes the threshold depending on a target value and a measured value of the communication quality indicator.

2. A threshold determination device adapted to a base station device configured to measure received power of a connection request signal from a terminal device, comprising a threshold determination part configured to determine a threshold regarding whether to permit the terminal device to be connected to the base station device in connection with a communication quality indicator,
wherein the base station device does not permit the terminal device to be connected thereto when the received power is lower than the threshold, and
wherein the threshold determination part changes the threshold depending on a target value and a measured value of the communication quality indicator.

3. The threshold determination device according to claim 2, wherein the threshold determination part increases or decreases the threshold to reduce a difference between the measured value and the target value of the communication quality indicator.

4. The threshold determination device according to claim 3, wherein the threshold determination part increases the threshold when the measured value of the communication quality indicator is lower than the target value of the communication quality indicator.

5. The threshold determination device according to claim 3, wherein the threshold determination part decreases the threshold when the measured value of the communication quality indicator is higher than the target value of the communication quality indicator.

6. The threshold determination device according to claim 2, wherein the threshold determination part determines a minimum threshold depending on a wireless communication environment in a communication area of the base station device.

7. The threshold determination device according to claim 2, wherein the threshold determination part determines the threshold which remains stable within a predetermined variation.

8. A threshold determination method adapted to a base station device configured to measure received power of a connection request signal from a terminal device, comprising:
determining a threshold regarding whether to permit the terminal device to be connected to the base station device with respect to a communication quality indicator, wherein the base station device does not permit the terminal device to be connected thereto when the received power is lower than the threshold; and
changing the threshold depending on a target value and a measured value of the communication quality indicator.

9. The threshold determination method according to claim 8, wherein the threshold is increased or decreased to reduce a difference between the measured value and the target value of the communication quality indicator.

10. A computer-readable storage medium having stored therein a computer program causing a computer to implement the threshold determination method according to claim 8.

11. A computer-readable storage medium having stored therein a computer program causing a computer to implement the threshold determination method according to claim 9.
